(19) United States
(12) Patent Application Publication
(10) Pub. No.: US 2025/0043676 A1
(43) Pub. Date: Feb. 6, 2025

(54) APPROACHES TO SUCKER ROD PUMP OPTIMZATION

(71) Applicant: Schlumberger Technology Corporation, Sugar Land, TX (US)

(72) Inventors: Agustin Gambaretto, Houston, TX (US); Miguel Angel Hernandez de la Bastida, Sugar Land, TX (US); Lichi Deng, Spring, TX (US); Saket Srivastava, Houston, TX (US); Moldir Yermekova, Houston, TX (US)

(21) Appl. No.: 18/793,373

(22) Filed: Aug. 2, 2024

Related U.S. Application Data
(60) Provisional application No. 63/517,361, filed on Aug. 3, 2023.

(51) Int. Cl. E21B 47/009; G16Y 40/10; G16Y 40/20

(52) U.S. Cl. CPC E21B 47/009; G16Y 40/10; G16Y 40/20

(57) ABSTRACT

A device includes a memory configured to store first executable code and a processor coupled to the memory. The processor is configured to calculate performance indicators for a sucker rod pump (SRP) based on performance data of the SRP, determine an operational frequency corresponding to operation of the SRP based on one performance indicator selected from the performance indicators, and initiate transmission of a control signal corresponding to the operational frequency to alter operation of the SRP to correspond to the operational frequency.

### CROSS-REFERENCE TO RELATED APPLICATIONS

This application claims priority to U.S. Provisional Patent Application Ser. No. 63/517,361, which was filed on Aug. 3, 2023, which is incorporated herein by reference in its entirety.

### BACKGROUND

The present disclosure generally relates to systems and methods for the control of rod pump operations.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Rod pumps (e.g., rod lifts or sucker rod pumps (SRP)) are one of the leading artificial lift system (ALS) employed worldwide, especially for low oil producer wells. Yet, rod pumps have typically been overlooked in the ongoing wave of digitalization within oil and gas production. Instead, rod pump operation as well as optimization processes tend to use traditional techniques, which may be based on field legacy ‘rule of thumb’ practices. Employing these techniques can lead to reduced production of the rod pumps, increases in shutdown events, and the like. Additionally these techniques can require user expertise for optimal operation of the rod pump, which can be difficult to scale.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates a rod pump system and equipment associated therewith, in accordance with an embodiment of the present disclosure;

FIG. 2 illustrates an embodiment of an edge device as the computing device of FIG. 1, in accordance with an embodiment;

FIG. 3 illustrates an embodiment of a method of controlling an operational characteristic of the sucker rod pump of FIG. 1, in accordance with an embodiment of the present disclosure; and

FIG. 4 illustrates examples of alteration of an operational characteristic of the sucker rod pump in accordance with the method of FIG. 3, in accordance with an embodiment of the present disclosure.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening components between those coupled), and is not limited to either unless expressly referenced as such. The term “set” may refer to one or more items. The following detailed description refers to the accompanying drawings. Wherever convenient, the same reference numbers are used in the drawings and the following description to refer to the same or similar parts. While several embodiments and features of the present disclosure are described herein, modifications, adaptations, and other implementations are possible, without departing from the spirit and scope of the present disclosure.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

Present embodiments described herein generally relate to the control and setting of desired operational characteristics (e.g., optimization) of a rod lift (also referred to as a rod pump or a sucker rod pumps (SRP)). Present embodiments discloses herein utilize at least one computing device to autonomously optimize SRP production while minimizing pump shutdowns. In some embodiments, the computing device can be an edge device, such as an edge gateway device, which uses or is part of an Industrial Internet of Things (IIoT)) framework. An optimization technique can be implemented via the computing device that operates to gathers trending operational data from a controller of the SRP system. The data can be gathered in connection with a time moving window, which can represents a well snapshot that is used to evaluate performance indicators at different operating pump frequencies. These calculated performance indicators can represent preset indicators, such as a Production Indicator (PI) and Combined Indicators (CI), which can be a function of pump fillage, strokes per minute, and well shutdowns. PI can represent an operational mode that prioritizes higher well production while CI can represent an operational mode that penalizes shutdowns to reduce pump failure rates. The computing device operates to dynamically evaluate the well performance indicators to recommend and implement an optimal frequency setpoint to the pump controller that is chosen based on the selected preset indicator chosen.

This technique can be run on a computing device. More particularly, the technique can be implements as an Edge Application, able to be run directly on site in an IIOT edge device (e.g., an edge gateway device). The techniques as implemented herein provide a replicable tool that can be deployed (i.e., scaled) to manage multiple wells by providing optimal setpoints based on pump-specific conditions for each well. Additionally, features like user configurable optimization cycle duration allowed for a faster well-optimization. Through the use of real time performance indicators of well production and shutdowns, the present embodiments provide an autonomously run, edge-based solution that requires no manual intervention and can be scaled to operate with hundreds or more wells.

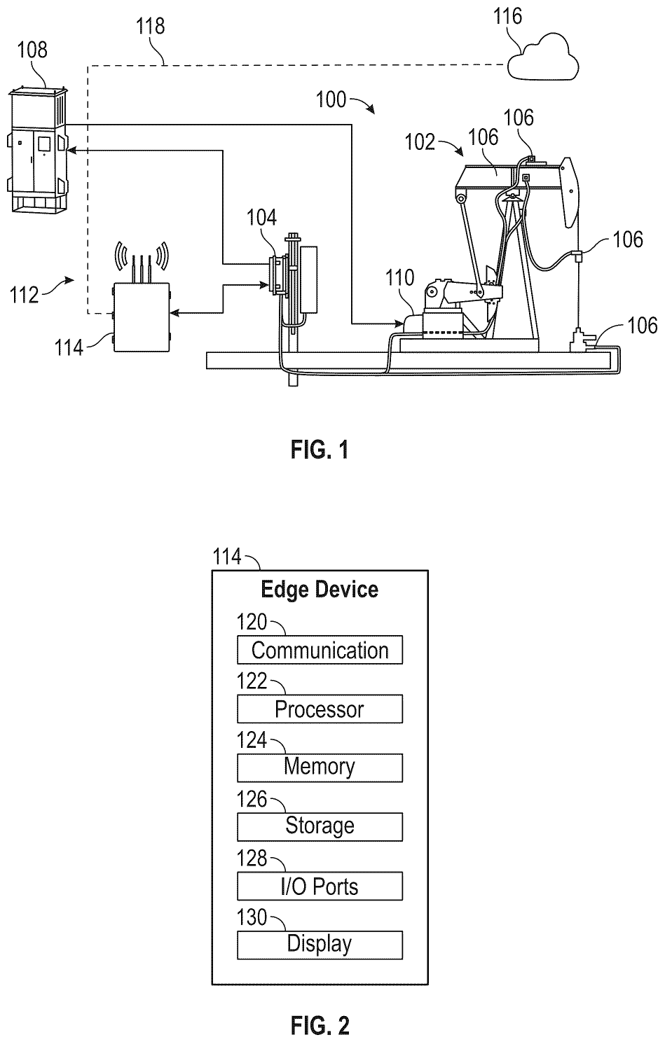

With the foregoing in mind, FIG. 1 illustrates a rod pump system 100. The rod pump system can include, for example, a sucker rod pump (SRP) 102 (also referred to as a rod pump or a rod lift) used in the extraction of natural resources, for example, oil. The rod pump system 100 can additionally include a rod pump controller 104. The rod pump controller 104 (e.g., pump off controller) is a controller that include an application specific integrated circuit or a processor and that operates to receive one or more sensor signals, generate one or more control signals based at least in part on the one or more sensor signals, and transmit the one or more control signals to control an operation of the SRP. For example, the rod pump controller 104 can be coupled to one or more sensors 106, which can include one or more of an inclinometer to measure angles of slope, elevation, or depression of an object (e.g., a beam of the SRP 102), a load cell to measure force or weight, a pressure sensor to measure fluid pressures (e.g., pressure of the fluids pumped from a downhole pump of the SRP 102 for use in determining flowrate of the SRP 102), and/or other similar sensing devices.

The rod pump controller 104 can also be coupled to other associated equipment of the rod pump system 100, for example, a variable frequency drive (VFD) 108. While a VFD 108 is illustrated, it should be appreciated that a variable speed drive (VSD) can instead be substituted for the VFD 108 and the operations described herein can instead be applied to the (VSD). In operation, the VFD 108 can operate as a power supply for a prime mover 110 (e.g., an electric motor) of the rod pump system 100, which provides power to the SRP 102 to generate the reciprocating motion of the SRP 102 that lifts and lowers a rod string connected to a subsurface pump used in the extraction of natural resources. The VFD 108 can operate to control the motor input frequency and voltage transmitted to the prime mover and, thereby, control operational characteristics (e.g., rate of operation) of the SRP 102. Utilization of a VFD 108 in the rod pump system 100 allows the SRP 102 to change from a pump that operates at a single speed, resulting in a single flow rate produced, to a pump that can operate at variable speeds, resulting in a range of flow rates that can be produced by the SRP 102. In some embodiments, the rod pump controller 104 operates to transmit a control signal to set the operational characteristics of the VFD 108, for example, the motor input frequency and voltage transmitted to the prime mover 110 so as to control the operation of the SRP 102 (its operational speed and, accordingly, the flow rate produced by the SRP 102).

There also exists systems for remote monitoring of the rod pump system 100. For example, one system to allow for remote monitoring the rod pump system is an Industrial Internet of Things (IIoT) system. IIoT can allow for local industrial networks or systems to provide access to data from outside the local area. FIG. 1 illustrates an example of an Industrial Internet of Things (IIoT) system 112. As illustrated, the IIoT system 112 includes at least one edge device 114, and a cloud 116 (e.g., an IIoT cloud platform). The edge device 114 can be, for example, a gateway, a node, or another network element that allows for transmission of data to and from the cloud 116. One or more edge devices 114 can be locally disposed at an industrial location, such as a location of the rod pump system 100.

In some embodiments, data collected by the rod pump controller 104 can be transmitted to the edge device 114 via, for example, a physical connection, such as Ethernet, a direct serial connection, etc. and/or via a wireless connection, such as, Bluetooth, Wi-Fi, or another wireless connection. In some embodiments, the edge device 114 can transmit the data received to the cloud 116 via a wireless network connection 118 (e.g., using 3G, 4G, LTE, or similar communication networks). In some embodiments described herein, there need not be any wireless network connection 118 utilized to perform the techniques described herein. Instead, one or more of the control techniques described herein can be performed using the edge device 114 separate from its connection to cloud 116 (i.e., the techniques described herein can be performed on site by the edge device 114).

Referring now to FIG. 2, an example of the edge device 114 may include any suitable industrial computing device, or the like and may include various components to perform various analysis operations. As shown in FIG. 2, the edge device 114 may include a communication component 120, a processor 122, a memory 124, a storage component 126, input/output (I/O) ports 128, a display 130, and the like. The communication component 120 may be a wireless or wired communication component that may facilitate communication between different monitoring systems, communication devices, various control systems, and the like. The processor 122 may be any type of computer processor or microprocessor capable of executing computer-executable code. Additionally, the processor 122 may also include multiple processors that may perform the operations described herein. It should also be noted that while processor 122 is illustrated, in some embodiments, additional processing circuitry, for example, accelerators, such as tensor processing units (TPUs) graphics processing units (GPUs) GPU), or other processing circuitry may be present in the edge device 114. In some embodiments, these additional processing circuitry can operate as a processor that performs one or more of the operations described herein, for example, by executing instructions stored in media to perform one or more of the operations described herein.

The memory 124 and the storage component 126 may be any suitable articles of manufacture that can serve as media to store processor-executable code, data, or the like. These articles of manufacture may represent non-transitory computer-readable media (i.e., any suitable form of memory or storage) that may store the processor-executable code used by the processor 122 to perform the presently disclosed techniques. The memory 124 and the storage component 126 may also be used to store data received via the I/O ports 128, data analyzed or transmitted by the processor 122, or the like.

The I/O ports 128 may be interfaces that may couple to various types of I/O modules and/or as an interface to enable the edge device 114 to connect and communicate with surface instrumentation, such as the rod pump controller 104, servers, and the like. It should be noted that the display 130 can be optional and is not present in some embodiments of the edge device 114. However, in embodiments where the display 130 is preset as part of the edge device, the display 130 may include any type of electronic display such as a liquid crystal display, a light-emitting-diode display, and the like. In these embodiments, for example, data acquired via communication component 120 and/or data analyzed by or modified by the processor 122 may be presented on the display 130. Likewise, operational information of the edge device 114 can be presented on the display 130. In certain embodiments, the display 130 may be a touch screen display or any other type of display capable of receiving inputs from an operator. Although the edge device 114 is described as including the components presented in FIG. 2, the edge device 114 should not be limited to including the components listed in FIG. 2. Indeed, the edge device 114 may include additional or fewer components than described above.

It should also be noted that for the sake of modularity and flexibility with regard to both the size and specifications of the targeted facility optimization problem, the edge device 114 may be implemented over a web application with back-end and front-end components. In this scheme, the back-end component may be responsible for handling certain optimization algorithms of the edge device 114, while the front-end component may be used to set optimization problem specifications and parameters from a user's perspective as detailed further below. The communication between the front-end component and back-end component of the edge device 114 may involve communications over any suitable network.

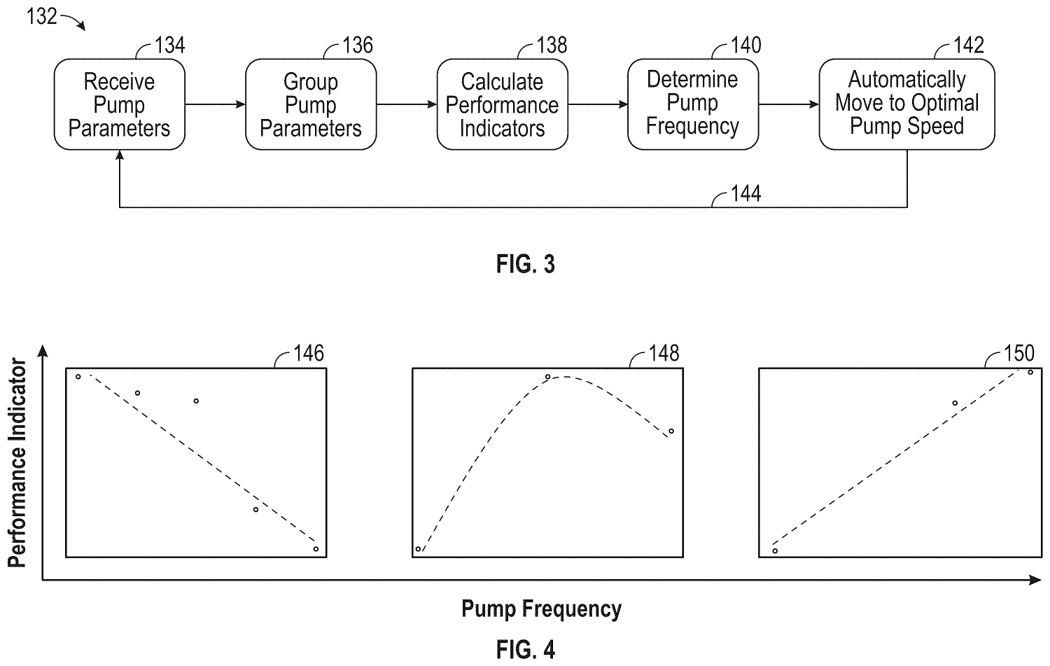

In one embodiment, the memory 124 and/or the storage component 126 can store one or more data structures, which are executed by the processor 122. The data structures can be edge applications, which are able to be run directly on site on the edge device 114 (e.g., via the processor 122 executing instructions stored in the memory 124 and/or the storage component 126). One example, of such a data structure is an optimization algorithm for the SRP 102, which will be described in greater detail below with respect to FIG. 3.

Returning to FIG. 1, the rod pump controller 104 is important to the operation of the rod pump system 100 and, particularly, the SRP 102. The rod pump controller 104 can provide a range of management methods, including timers and various operating modes. The rod pump controller 104 typically relies on predefined settings, which can encompass, for example, minimum and maximum speed set points and downtime intervals for pump cycling. These settings, once set, do not typically automatically adapt to changing well conditions and, instead, require manual adjustment, which can introduce subjectivity to their operation.

One control method employed by the rod pump controller 104 revolves around managing primary control pump fillage (e.g., the VFD 108 reduces the pumping speed (strokes per minute, or SPM) of the SRP 102 if pump fillage goes below a pre-determined or user-defined value) and secondary control pump fillage (e.g., the VFD 108 will shut down the well if pump fillage (PF) goes below a pre-determined or user-defined value) set points. Furthermore, the rod pump controller 104 can be used to control over upper and lower limits of frequency set points of the VFD 108. However, incorrect setting of these limits can lead to reduced efficiency and even damage of components of the SRP 102. Moreover, the rod pump controller 104 is not typically able to determine control signals (e.g., values thereof) to allow for autonomous optimization of SRP 102 production.

Techniques described herein can operate to mitigate the challenges described above, including excessive cycling, underperformance, or incomplete fillage. This can enhance well efficiency and reduce the risk of pump failures. The techniques described herein can be performed by a computing device including a processor executing instructions stored in the memory and/or a storage component to execute instructions to implement the techniques described herein. In one embodiment, as discussed with respect to FIG. 3, the computing device used in the implementation of the techniques is the edge device 114, which can operate to provide autonomous optimization of SRP 102 production.

FIG. 3 illustrates a method 132 of controlling an operational characteristic of the SRP 102. As noted above, the method 132 can be implemented by a computing device, for example, the edge device 114 implementing an optimization algorithm (e.g., as a data structure, such as an edge application) for the SRP 102. Initially, the optimization algorithm can be set up based on local conditions of the rod pump system 100 and/or based on user supplied preferences. For example, setup values can be provided to the edge device 114 to initiate the optimization algorithm for use in conjunction with a particular rod pump system 100. These setup values can be input locally to the edge device 114 on-site, transmitted to the edge device 114 via, for example, the I/O ports 128, or can be programmed prior to the edge detector being deployed on location with the rod pump system 100.

Inputs for setting up the optimization algorithm can include, for example, one or more of a sample set size value, an operating (or optimization) mode value, an auto-mode value, and an enable value. In some embodiments, the sample set size value can include a window value that represents a fixed size of historical data to be ingested and utilized by the optimization algorithm. The sample set size value can also include a period value representing a duration by which the window of a fixed size of historical data slides forward (i.e., the frequency or how often the optimization algorithm reviews optimization values, recommends new optimization values, and/or generates control signals as well as the new starting point in time for the window of historical data used in generating the slide). In some embodiments, the time period of the window data value can be measured in days or weeks, for example, three days, five days, seven days, ten days, fourteen days, twenty-one days, or another amount of time. Likewise, the time period of the period value can be measured in minutes or hours, for example, one hour, four hours, six hours, eight hours, ten hours, twelve hours, eighteen hours, twenty-four hours, or another amount of time.

The operating (or optimization) mode value can represent optimization settings that can be applied to optimize particular aspects of the operation of the SRP 102 (e.g., the well performance of the SRP 102) when implementing the optimization algorithm. For example, a first operating mode value can be a Production Indicator (PI) mode. The PI mode can establish a direct relationship with the flowrate of the SRP 102 corresponding to the duration of the speed setpoint of the SRP 102. Primarily, the PI mode is used to identify a setpoint that maximizes fluid production by the SRP 102 when operating in the PI mode as the selected operating mode for the optimization algorithm. A second operating mode value can be a Combined Indicator (CI) mode. CI mode is similar to PI mode, in that Cl mode operates to enhance fluid production by the SRP 102. However, CI mode differs from PI mode in that it accounts for the impact of well shutdowns on overall production. This can be achieved by incorporating penalties for shutdown events when operating in the CI mode as the selected operating mode for the optimization algorithm. A third operating mode value can be a Combined Indicator-Quadratic Penalty (CI-QP) mode. CI-QP mode can be, for example, an extension of the CI mode in that CI-QP mode assesses the same metrics as CI mode, but CI-QP mode imposes a more severe penalty on well shutdowns than CI mode when operating in the Cl-QP mode as the selected operating mode for the optimization algorithm. The CI-QP mode can be valuable, for example, when a control secondary PF setpoint of a well or speed of the VFD 108 was set too high, resulting in excessive cycling by bringing the well to a stable condition through reduction of excessive shutdowns. Moreover, while three operating mode values are described above, more or less than these three operating mode values can be utilized in selecting the operating mode for the optimization algorithm.

In some embodiments, the auto-mode value as an (initial) setup value for the optimization algorithm corresponds to whether the optimization algorithm is to be operated in a fully autonomous mode or, for example, in a partially autonomous mode that includes user inputs. Likewise, in some embodiments, the enable value as an (initial) setup value for the optimization algorithm corresponds to whether the optimization algorithm is to be activated (i.e., on) or deactivated (i.e., off). As noted above, one of more of these setup values for the optimization algorithm can be provided to the edge device 114 to initiate the optimization algorithm for use in conjunction with a particular rod pump system 100. In this manner, the optimization algorithm can be tailored for use with a particular rod pump system 100 and can take into account user preferences on the operation of the optimization algorithm. However, the varied setup values also allow for scalability, since respective edge detectors 114 each having a customizable optimization algorithm stored therein can be deployed to a multitude of locations and individually set up based on customer needs at those locations.

Block 134 represents acquisition of pump parameters (i.e., data) of the SRP 102 by the edge device 114 from the rod pump controller 104. These data values can be transmitted by the rod pump controller 104 either wirelessly or via a tethered connection to the edge device 114. The data transmitted to the edge device 114 can include, for example, SPM of the SRP 102, the PF of the SRP 102 (i.e., the quantity of fluid entering the SRP 102 during each stroke of the SRP 102), pump working speed, shutdowns, and/or other SRP 102 operational data. The pump parameters that are transmitted and received in conjunction with block 134 can be a history of pump parameters. This history of pump parameters can be edited to correspond to the window of time selected as the window value (e.g., data from 7 days prior) by the optimization algorithm operating on the edge device 114. In other embodiments, an edited set of pump parameters that correspond to the window of time selected as the window value can be requested by the edge device 114 from the rod pump controller 104.

In block 136, the pump parameters (corresponding to the window of time selected as the window value) are grouped via the optimization algorithm operating on the edge device 114. The grouping in block 136 can correspond to including data that corresponds to a given pump frequency together. That is, data received is grouped together in a first group when the VFD 108 was generating a first motor input frequency and the data received is grouped together in a second (or additional) group when the VFD 108 was generating a second (or additional) motor input frequency. In this manner, performance characteristics of the SRP 102 are assigned to groups based on operational characteristics of the SRP 102 when the data was generated.

In block 138, the optimization algorithm operating on the edge device 114 calculates performance indicators. In some embodiments, these performance indicators are calculated using the grouped pump parameters of block 138. Additionally, the performance indicators are calculated for one or more potential pump frequencies (i.e., one or more motor input frequencies to be transmitted from the VFD 108 to the SRP 102). The performance indicators that are calculated in block 138 will be calculated based upon the operating mode value of the optimization algorithm.

For example, when the PI mode is selected as the operating mode for the optimization algorithm, the optimization algorithm operating on the edge device 114 calculates PI in block 138. In some embodiments, PI can be calculated as, for example, a product of PF and SPM. Additionally, when the CI mode is selected as the operating mode for the optimization algorithm, the optimization algorithm operating on the edge device 114 calculates PI in block 138. In some embodiments, CI can be calculated as, for example, PI divided by shutdowns. Similarly, when the CI-QP mode is selected as the operating mode for the optimization algorithm, the optimization algorithm operating on the edge device 114 calculates CI-QP in block 138. In some embodiments, CI-QP can be calculated as, for example, PI divided by shutdowns with an increased penalty for shutdowns relative to CI.

The calculated performance indicators (i.e., PI, CI, or CI-QP) in block 138 can be generated for a series of possible potential pump frequencies (i.e., one or more motor input frequencies to be transmitted from the VFD 108 to the SRP 102) as potential speed setpoints. Additionally, in block 138, in instances where a speed setpoint repeats within a historical data window, the indicator values can be averaged to ensure a comprehensive assessment. The focus of the calculated performance indicators can be on inferred production and, as noted above, the performance indicators can be primarily influenced by SPM, pump fillage, and shutdown events.

In block 140, the optimization algorithm operating on the edge device 114 determines (i.e., calculates) a pump frequency. This pump frequency can be selected as a VFD 108 motor input frequency to be transmitted from the VFD 108 to the SRP 102. In some embodiments, the pump frequency of block 140 is determined as an optimal frequency by the optimization algorithm operating on the edge device 114. In other embodiments, the pump frequency in block 140 is provided as a set increase or decrease in frequency to the current input frequency transmitted from the VFD 108 to the SRP 102. For example, in some embodiments, fixed increases in frequency can be applied by the VFD 108 of, for example 1 Hz. Thus, if an optimal change in pump frequency is 2 Hz higher than a current VFD 108 motor input frequency, the determined pump frequency in block 140 for alteration can be 1 Hz higher than the VFD 108 motor input frequency. In other embodiments, larger increases of VFD 108 motor input frequency (e.g., 5 Hz changes) can be undertaken, for example, upon restart of a well, to more rapidly approach a determined optimal pump speed. Subsequent to one or more of the larger increases being implemented, the optimization algorithm operating on the edge device 114 can revert to predetermined increases described above (e.g., 1 Hz increases/decreases in the speed setpoints determined).

In implementing the operations of block 140 via the optimization algorithm operating on the edge device 114 dynamically analyzes the calculated frequency setpoints of block 138. From the set of calculated frequency setpoints of block 138, the optimization algorithm in block 140 determines a best (e.g., optimal) setpoint from the set of calculated frequency setpoints. In one embodiment, the determination of a best (e.g., optimal) setpoint from the set of calculated frequency setpoints includes selection of a setpoint (e.g., a speed setpoint) that is higher than the current speed setpoint, lower than the current speed setpoint, or the same as the current speed setpoint. The values for the higher speed setpoint and lower speed setpoints can be fixed values, for example, 1 Hz different than the current speed setpoint. In this manner, the optimization algorithm operating on the edge device 114 in block 140 determines the optimal direction to move with respect to the currently implemented speed setpoint; either faster (up), slower (down), or remain the same until the next optimization cycle is performed.

In block 142, the optimization algorithm operating on the edge device 114 can transmit a control signal to the rod pump controller 104 to initiate a change the current input frequency transmitted from the VFD 108 to the SRP 102 by the rod pump controller 104. In this manner, the optimization algorithm operating on the edge device 114 can initiate moving of the pump speed of the SRP 102 to a determined optimized point automatically, i.e., without intervention. Additionally, FIG. 3 illustrates path 144 which corresponds to the period value of the optimization algorithm. Path 144 represents a duration of time by which the window of a fixed size of historical data slides forward (i.e., the new starting point in time for the window of historical data used in generating the optimized pump frequency value in block 140. Path 144 also represents the amount of time until the optimization algorithm operating on the edge device 114 reviews optimization values, recommends new optimization values, and/or generates control signals in conjunction with block 134, block 136, block 138, block 140, and block 142 (i.e., the next optimization cycle).

FIG. 4 includes a graph 146 illustrating an example of a performance trend decreasing for the SRP 102, a graph 148 illustrating an example of a performance trend stabilized for the SRP 102, and a graph 150 illustrating an example of a performance trend increasing for the SRP 102. Graph 146 illustrates a 7-day rolling window of production indicator values plotted against operating frequencies (e.g., of the VFD 108 or a VSD). Graph 146 illustrates the date that is utilized by the optimization algorithm operating on the edge device 114 to determine an optimal speed setpoint. The forecast illustrated in graph 146 forecasts a scenario where the performance trend is decreasing. Accordingly, a further increase in pump speed would lead to a further decline in production performance of the SRP 102. Therefore, the recommendation generated by the optimization algorithm operating on the edge device 114 is to decrease the frequency of the VFD 108 (or VSD) by a set amount (e.g., 1 Hz) in conjunction with method 132.

Graph 148 illustrates a 7-day rolling window of production indicator values plotted against operating frequencies (e.g., of the VFD 108 or a VSD). Graph 148 illustrates the date that is utilized by the optimization algorithm operating on the edge device 114 to determine an optimal speed setpoint. The forecast illustrated in graph 148 forecasts a scenario where the performance trend aligns with the center of the curve in graph 148. Accordingly, the recommendation generated by the optimization algorithm operating on the edge device 114 is to maintain the current frequency setpoint. This would continue until the indicator signals that the existing frequency is no longer the optimal choice.

Graph 150 illustrates a 7-day rolling window of production indicator values plotted against operating frequencies (e.g., of the VFD 108 or a VSD). Graph 150 illustrates the date that is utilized by the optimization algorithm operating on the edge device 114 to determine an optimal speed setpoint. The forecast illustrated in graph 150 forecasts a scenario where the performance trend is increasing. Accordingly, a further increase in pump speed would lead to a further increase in production performance of the SRP 102. Therefore, the recommendation generated by the optimization algorithm operating on the edge device 114 is to increase the frequency of the VFD 108 (or VSD) by a set amount (e.g., 1 Hz) in conjunction with method 132.

The technical effect of the disclosed embodiments includes solutions generated by the optimization algorithm operating on the edge device 114, which can help manage multiple wells by providing optimal setpoints based on pump-specific conditions. Additionally, features like user configurable optimization cycle duration can provide for faster well-optimization. In this manner, the optimization algorithm operating on the edge device 114 can help evaluate trending data leveraging on IIOT to optimize SRP 102 operation using real time performance indicators of well production and shutdowns. Additionally, the optimization algorithm operating on the edge device 114 can operate as an autonomous, edge-based solution that requires little or no manual intervention and can be scaled to multiple hundred wells.

Since SRP 102 wells often account for low oil producing wells, many operators overlook optimizing its operating conditions. Yet, rod failures are generally proportional to operating conditions like pump cycles per day, optimum SPM, and pump fillage conditions. Some examples where the solution disclosed herein (i.e., implementation of the optimization algorithm operating on the edge device 114) can improve SRP 102 performance are discussed below.

With respect to high cycling wells, well shutdowns are often frequent, meaning VFD 108 speed is not optimized or set at higher value. In this case, Pump Intake Pressure (PIP) may be too low for the VFD 108 speed settings, thus pump shutdowns can occur when pump fillage drops below the certain threshold. The pump cycle may increase pump stress levels and affect pump run life negatively. Use of the optimization algorithm operating on the edge device 114 can improve SRP 102 performance for high cycling wells.

With respect to wells producing at low pump fillage conditions, a well may be pumping at low pump fillage without shutdowns. This can indicate that the pump fillage threshold is not set up or not activated by the operator. Pumping at low fillage may cause buckling, and excessive wear on the rods, which can lead to rod failure. Use of the optimization algorithm operating on the edge device 114 can improve the SRP 102 operation to alleviate these potential outcomes.

With respect to SRPs 102 producing at full pump fillage, when wells that have high PIP, being set at a lower or an un-optimized operating setpoint can reduce well production relative to the ability of the well to produce when operating at an optimized setpoint. Additionally, fluid levels may not be measured frequently enough for engineers or operators to notice and correct this situation, which can lead to lost production. Use of the optimization algorithm operating on the edge device 114 can improve the SRP 102 operation to alleviate these potential outcomes.

With respect to dynamic well conditions, in traditional oilfield practices, production engineers may review a well and change frequency set points manually to optimize productivity. However, well conditions may change dynamically and the current optimal setpoint might not be optimal in the future. Additionally, this setpoint recommendation process is generally manual and open to human interpretation and errors. Use of the optimization algorithm operating on the edge device 114 can improve the SRP 102 operation to alleviate these potential outcomes.

The approach disclosed herein can help evaluate pump parameters and create calculated variables (e.g., PI, CI, or CI-QP) that depend on wells pump fillage and frequency. The approach may evaluate if a pump is operating at its the most efficient operating conditions. As the reservoir and well conditions change, the calculated variables may also change, and the optimization algorithm operating on the edge device 114 can will continue to search for and find optimal operating setpoints.

In one embodiment, the optimization algorithm penalizes shutdowns and reduces the speed and avoids high cycling.

In one embodiment, the optimization algorithm reduces speed when pump fillage is dropping below set points and aims for stable pumping conditions, to prevent premature pump failing.

In one embodiment, the optimization algorithm constantly increases the speed during high pump fillage to optimal SPM and pump fillage values, thus avoiding production deferment and inefficient operation.

In one embodiment, the optimization algorithm is autonomous and accounts for wells dynamic conditions. It requires no human interventions, thus minimizing errors. In certain embodiments, the solution generates data during operation that may be used for further development of SRP 102 applications.

Accordingly, an optimization algorithm may be implemented on an edge device 114. The optimization algorithm may receive and process high-frequency data and apply changes to operation to the well in real-time. The optimization algorithm may use calculated variables (e.g., PI, CI, or CI-QP) in providing recommended operating control signals. The optimization algorithm also facilitates autonomous functioning and/or remote control. The optimization algorithm may facilitate improved runtime, reduced production deferment and production loss, the reduction of human intervention and human errors, and account for reservoir and well conditions.

The subject matter described in detail above may be defined as set forth below.

A device includes a memory configured to store first executable code and a processor coupled to the memory and configured to calculate performance indicators for a sucker rod pump (SRP) based on performance data of the SRP, determine an operational frequency corresponding to operation of the SRP based on one performance indicator selected from the performance indicators, and initiate transmission of a control signal corresponding to the operational frequency to alter operation of the SRP to correspond to the operational frequency.

The device of the preceding clause, further comprising an input/output (I/O) port configured to receive the performance data from a rod pump controller coupled to the SRP.

The device of any of the preceding clauses, wherein the I/O port is configured to transmit the control signal to the rod pump controller to control operation of a variable drive device by the rod pump controller.

The device of any of the preceding clauses, wherein the processor is further configured to calculate the performance indicators for the SRP based on grouped performance data as the performance data.

The device of any of the preceding clauses, wherein the processor is further configured to generate the grouped performance data based on whether the performance data corresponds to a common operational frequency of the SRP.

The device of any of the preceding clauses, wherein the processor is further configured to calculate the performance indicators based on which operating mode of a plurality of operating modes is provided.

The device of any of the preceding clauses, wherein the processor is further configured to calculate the performance indicators utilizing a strokes per minute (SPM) measurement of the SRP and a pump fillage (PF) measurement of the SRP when the operating mode comprises a first operating mode configured to prioritize fluid production by the SRP.

The device of any of the preceding clauses, wherein the processor is further configured to calculate the performance indicators utilizing the SPM measurement of the SRP and the PF measurement of the SRP in conjunction with a first penalty value corresponding to a shutdown of a well associated with the SRP when the operating mode comprises a second operating mode configured to incorporate penalties for the shutdown of the well.

The device of any of the preceding clauses, wherein the processor is further configured to calculate the performance indicators utilizing the SPM measurement of the SRP and the PF measurement of the SRP in conjunction with a second penalty value corresponding to the shutdown of the well when the operating mode comprises a third operating mode configured to incorporate heightened penalties for the shutdown of the well relative to the penalties of the second operating mode.

The device of any of the preceding clauses, wherein the processor is further configured to calculate the performance indicators as each corresponding to a fixed motor input frequency utilized by the SRP.

The device of any of the preceding clauses, comprising an Industrial Internet of Things (IIoT) edge device.

A memory includes instructions configured to cause a processor of an Industrial Internet of Things (IIoT) edge device to execute first executable code stored in the memory of the IIoT edge device to calculate performance indicators for a sucker rod pump (SRP) based on performance data of the SRP, determine an operational frequency corresponding to operation of the SRP based on one performance indicator selected from the performance indicators, and initiate transmission of a control signal corresponding to the operational frequency to alter operation of the SRP to correspond to the operational frequency.

The memory of the preceding clause, wherein the instructions cause the processor of the IIoT edge device to calculate the performance indicators based on which operating mode of a plurality of operating modes is provided.

The memory of any of the preceding clauses, wherein the instructions cause the processor of the IIoT edge device to calculate the performance indicators utilizing a strokes per minute (SPM) measurement of the SRP and a pump fillage (PF) measurement of the SRP when the operating mode comprises a first operating mode configured to prioritize fluid production by the SRP.

The memory of any of the preceding clauses, wherein the instructions cause the processor of the IIoT edge device to calculate the performance indicators utilizing the SPM measurement of the SRP and the PF measurement of the SRP in conjunction with a first penalty value corresponding to a shutdown of a well associated with the SRP when the operating mode comprises a second operating mode configured to incorporate penalties for the shutdown of the well.

The memory of any of the preceding clauses, wherein the instructions cause the processor of the IIoT edge device to calculate the performance indicators utilizing the SPM measurement of the SRP and the PF measurement of the SRP in conjunction with a second penalty value corresponding to the shutdown of the well when the operating mode comprises a third operating mode configured to incorporate heightened penalties for the shutdown of the well relative to the penalties of the second operating mode.

A method includes storing first executable code in a memory of an Internet of Things (IIoT) edge device and executing the first executable code via a processor coupled to the memory to calculate performance indicators for a sucker rod pump (SRP) based on performance data of the SRP, determine an operational frequency corresponding to operation of the SRP based on one performance indicator selected from the performance indicators, and initiate transmission of a control signal corresponding to the operational frequency to alter operation of the SRP to correspond to the operational frequency.

The method of the preceding clause, further including calculating the performance indicators based on which operating mode of a plurality of operating modes is provided.

The method of any of the preceding clauses, further including calculating the performance indicators utilizing a strokes per minute (SPM) measurement of the SRP and a pump fillage (PF) measurement of the SRP when the operating mode comprises a first operating mode configured to prioritize fluid production by the SRP.

The method of any of the preceding clauses, further including calculating the performance indicators utilizing the SPM measurement of the SRP and the PF measurement of the SRP in conjunction with a first penalty value corresponding to a shutdown of a well associated with the SRP when the operating mode comprises a second operating mode configured to incorporate penalties for the shutdown of the well and calculating the performance indicators utilizing the SPM measurement of the SRP and the PF measurement of the SRP in conjunction with a second penalty value corresponding to the shutdown of the well when the operating mode comprises a third operating mode configured to incorporate heightened penalties for the shutdown of the well relative to the penalties of the second operating mode.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount. As another example, in certain embodiments, the terms “generally parallel” and “substantially parallel” or “generally perpendicular” and “substantially perpendicular” refer to a value, amount, or characteristic that departs from exactly parallel or perpendicular, respectively, by less than or equal to 15 degrees, 10 degrees, 5 degrees, 3 degrees, 1 degree, or degree.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

Likewise, the steps described need not be performed in the same sequence discussed or with the same degree of separation. Various steps may be omitted, repeated, combined, or divided, as appropriate to achieve the same or similar objectives or enhancements. Accordingly, the present disclosure is not limited to the above-described embodiments, but instead is defined by the appended claims in light of their full scope of equivalents. Further, in the above description and in the below claims, unless specified otherwise, the term “execute” and its variants are to be interpreted as pertaining to any operation of program code or instructions on a device, whether compiled, interpreted, or run using other techniques. In the claims that follow, section 112 paragraph sixth is not invoked unless the phrase “means for” is used.

What is claimed is:

1. A device, comprising:
a memory configured to store first executable code; and
a processor coupled to the memory and configured to:
calculate performance indicators for a sucker rod pump (SRP) based on performance data of the SRP;
determine an operational frequency corresponding to operation of the SRP based on one performance indicator selected from the performance indicators; and
initiate transmission of a control signal corresponding to the operational frequency to alter operation of the SRP to correspond to the operational frequency.

2. The device of claim 1, further comprising an input/output (I/O) port configured to receive the performance data from a rod pump controller coupled to the SRP.

3. The device of claim 2, wherein the I/O port is configured to transmit the control signal to the rod pump controller to control operation of a variable drive device by the rod pump controller.

4. The device of claim 1, wherein the processor is further configured to calculate the performance indicators for the SRP based on grouped performance data as the performance data.

5. The device of claim 4, wherein the processor is further configured to generate the grouped performance data based on whether the performance data corresponds to a common operational frequency of the SRP.

6. The device of claim 1, wherein the processor is further configured to calculate the performance indicators based on which operating mode of a plurality of operating modes is provided.

7. The device of claim 6, wherein the processor is further configured to calculate the performance indicators utilizing a strokes per minute (SPM) measurement of the SRP and a pump fillage (PF) measurement of the SRP when the operating mode comprises a first operating mode configured to prioritize fluid production by the SRP.

8. The device of claim 7, wherein the processor is further configured to calculate the performance indicators utilizing the SPM measurement of the SRP and the PF measurement of the SRP in conjunction with a first penalty value corresponding to a shutdown of a well associated with the SRP when the operating mode comprises a second operating mode configured to incorporate penalties for the shutdown of the well.

9. The device of claim 8, wherein the processor is further configured to calculate the performance indicators utilizing the SPM measurement of the SRP and the PF measurement of the SRP in conjunction with a second penalty value corresponding to the shutdown of the well when the operating mode comprises a third operating mode configured to incorporate heightened penalties for the shutdown of the well relative to the penalties of the second operating mode.

10. The device of claim 1, wherein the processor is further configured to calculate the performance indicators as each corresponding to a fixed motor input frequency utilized by the SRP.

11. The device of claim 1, comprising an Industrial Internet of Things (IIoT) edge device.

12. A memory, comprising instructions configured to cause a processor of an Industrial Internet of Things (IIoT) edge device to:
execute first executable code stored in the memory of the IIoT edge device to:
calculate performance indicators for a sucker rod pump (SRP) based on performance data of the SRP;
determine an operational frequency corresponding to operation of the SRP based on one performance indicator selected from the performance indicators; and
initiate transmission of a control signal corresponding to the operational frequency to alter operation of the SRP to correspond to the operational frequency.

13. The memory, of claim 12, wherein the instructions cause the processor of the IIoT edge device to calculate the performance indicators based on which operating mode of a plurality of operating modes is provided.

14. The memory, of claim 13, wherein the instructions cause the processor of the IIoT edge device to calculate the performance indicators utilizing a strokes per minute (SPM) measurement of the SRP and a pump fillage (PF) measurement of the SRP when the operating mode comprises a first operating mode configured to prioritize fluid production by the SRP.

15. The memory, of claim 14, wherein the instructions cause the processor of the IIoT edge device to calculate the performance indicators utilizing the SPM measurement of the SRP and the PF measurement of the SRP in conjunction with a first penalty value corresponding to a shutdown of a well associated with the SRP when the operating mode comprises a second operating mode configured to incorporate penalties for the shutdown of the well.

16. The memory, of claim 15, wherein the instructions cause the processor of the IIoT edge device to calculate the performance indicators utilizing the SPM measurement of the SRP and the PF measurement of the SRP in conjunction with a second penalty value corresponding to the shutdown of the well when the operating mode comprises a third operating mode configured to incorporate heightened penalties for the shutdown of the well relative to the penalties of the second operating mode.

17. A method, comprising:
storing first executable code in a memory of an Internet of Things (IIoT) edge device; and
executing the first executable code via a processor coupled to the memory to:
calculate performance indicators for a sucker rod pump (SRP) based on performance data of the SRP;
determine an operational frequency corresponding to operation of the SRP based on one performance indicator selected from the performance indicators; and
initiate transmission of a control signal corresponding to the operational frequency to alter operation of the SRP to correspond to the operational frequency.

18. The method of claim 17, further comprising calculating the performance indicators based on which operating mode of a plurality of operating modes is provided.

19. The method of claim 18, further comprising calculating the performance indicators utilizing a strokes per minute (SPM) measurement of the SRP and a pump fillage (PF) measurement of the SRP when the operating mode comprises a first operating mode configured to prioritize fluid production by the SRP.

20. The method of claim 19, further comprising calculating the performance indicators utilizing the SPM measurement of the SRP and the PF measurement of the SRP in conjunction with a first penalty value corresponding to a shutdown of a well associated with the SRP when the operating mode comprises a second operating mode configured to incorporate penalties for the shutdown of the well and calculating the performance indicators utilizing the SPM measurement of the SRP and the PF measurement of the SRP in conjunction with a second penalty value corresponding to the shutdown of the well when the operating mode comprises a third operating mode configured to incorporate heightened penalties for the shutdown of the well relative to the penalties of the second operating mode.
